(19) United States
(12) Patent Application Publication
(10) Pub. No.: US 2013/0335880 A1
(43) Pub. Date: Dec. 19, 2013

(54) CAPACITOR, STRUCTURE AND METHOD OF FORMING CAPACITOR

(71) Applicant: Taiyo Yuden Co., Ltd., Tokyo (JP)

(72) Inventor: Hidetoshi MASUDA, Tokyo (JP)

(21) Appl. No.: 13/915,286

(22) Filed: Jun. 11, 2013

(30) Foreign Application Priority Data
Jun. 14, 2012 (JP) 2012-134862

(51) Int. Cl. H01G 4/005

(52) U.S. Cl. CPC H01G 4/005
USPC 361/303; 29/25.41

(57) ABSTRACT

There is provided a capacitor including a dielectric layer having a first plane, a second plane opposite to the first plane, and a plurality of through-holes communicated with the first plane and the second plane, including a plurality of arrangement regions where arrangement directions of the plurality of through-holes are same; a first external electrode layer disposed on the first plane; a second external electrode layer disposed on the second plane; a first internal electrode housed in a part of the plurality of through-holes and connected to the first external electrode layer; and a second internal electrode housed in a part of the plurality of through-holes and connected to the second external electrode layer.

### CROSS-REFERENCE TO RELATED APPLICATION

This application claims priority under 35 U.S.C. §119 to Japanese Patent Application No. JP 2012-134862 filed on Jun. 14, 2012, the entire content of which is hereby incorporated herein by reference in its entirety.

### FIELD

The present disclosure relates to a capacitor, a structure and a method of forming a capacitor.

### BACKGROUND

In recent years, as a new type capacitor, a porous capacitor has been developed. The porous capacitor takes advantages of a tendency that a metal oxide formed on a surface of a metal such as aluminum forms a porous structure. The porous capacitor is configured by forming electrodes in pores and using the metal oxide as a dielectric. For example, Japanese Patent No. 4493686 discloses a capacitor where electrodes are formed in pores that are formed on a metal oxide.

### SUMMARY

However, in the capacitor described in Japanese Patent No. 4493686, the pores formed in the dielectric layer may decrease a mechanical strength. The capacitor is often mounted on a circuit board by soldering, and may be broken by a mechanical or thermal shock therefrom. During use, the capacitor may also be broken by a thermal stress etc. under high temperature conditions. Such a problem may become remarkable as the capacitor becomes light and compact.

In view of the above-mentioned circumstances, it is desirable to provide a capacitor having excellent strength, structure and a method of forming the capacitor.

According to an embodiment of the present disclosure, there is provided a capacitor including a dielectric layer, a first external electrode layer, a second external electrode layer, a first internal electrode, and a second internal electrode.

The dielectric layer includes a first plane, a second plane opposite to the first plane, and a plurality of through-holes communicated with the first plane and the second plane, including a plurality of arrangement regions where arrangement directions of the plurality of through-holes are same.

The first external electrode layer is disposed on the first plane.

The second external electrode layer is disposed on the second plane.

The first internal electrode is housed in a part of the plurality of through-holes and connected to the first external electrode layer.

The second internal electrode is housed in a part of the plurality of through-holes and connected to the second external electrode layer.

According to an embodiment of the present disclosure, there is provided a structure including a dielectric layer having a first plane, a second plane opposite to the first plane, and a plurality of through-holes communicated with the first plane and the second plane, including a plurality of arrangement regions where arrangement directions of the plurality of through-holes are same.

According to an embodiment of the present disclosure, there is provided a method of forming a capacitor including preparing a substrate including a plurality of pits orderly arranged, arrangement directions of the plurality of pits being same.

The dielectric layer is formed by anodic oxidizing the substrate.

A conductive material fills a plurality of through-holes formed in the dielectric layer by the anodic oxidation.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a perspective view showing a capacitor according to a first embodiment of the present disclosure;

FIG. 2 is a cross-sectional view of the capacitor;

FIG. 3 is a perspective view of a dielectric layer of the capacitor;

FIG. 4 is a schematic view showing a configuration of a first internal electrode and a second internal electrode in the dielectric layer of the capacitor;

FIG. 5 is a plan view showing the dielectric layer of the capacitor;

FIG. 6 is a plan view showing the dielectric layer of the capacitor;

FIG. 7 is a plan view showing the dielectric layer of a comparative capacitor;

FIGS. 8A to 8C each is a schematic view showing a method of forming the capacitor according to a first embodiment of the present disclosure;

FIGS. 9A to 9C each is a schematic view showing the method of forming the capacitor;

FIGS. 10A to 10C each is a schematic view showing the method of forming the capacitor;

FIGS. 11A to 11C each is a schematic view showing the method of forming the capacitor;

FIG. 12A to 12C each is a schematic view showing the method of forming the capacitor;

FIG. 13 is a schematic view showing a pit arrangement formed on a substrate in the method of forming the capacitor;

FIG. 14 is a table showing test results of structures according to Example and Comparative Example; and

FIG. 15 is a table showing test results of capacitors according to Example and Comparative Example.

### DETAILED DESCRIPTION OF THE EMBODIMENTS

According to an embodiment of the present disclosure, there is provided a capacitor including a dielectric layer, a first external electrode layer, a second external electrode layer, a first internal electrode, and a second internal electrode.

The dielectric layer includes a first plane, a second plane opposite to the first plane, and a plurality of through-holes communicated with the first plane and the second plane, including a plurality of arrangement regions, arrangement directions of the plurality of through-holes in each arrangement region being same.

The first external electrode layer is disposed on the first plane.

The second external electrode layer is disposed on the second plane.

The first internal electrode is housed in a part of the plurality of through-holes and connected to the first external electrode layer.

The second internal electrode is housed in a part of the plurality of through-holes and connected to the second external electrode layer.

By this configuration, a through-hole arrangement in one arrangement region is different from a through-hole arrangement in the other arrangement region, i.e., the trough-hole is not arranged in a certain direction over an entire area of the dielectric layer. In this way, the cracks are prevented from propagating, even when a mechanical or a thermal shock is added to the dielectric layer. Accordingly, it is possible to prevent capacitor properties from deteriorating caused by the breakage of the dielectric layer.

The through-holes in the arrangement regions may have a hexagonal ordered array.

By this configuration, it is possible to prevent the dielectric layer from broken even when the through-holes have the hexagonal ordered array.

The dielectric layer may be made of ceramics.

Ceramics may suffer from a brittle failure. However, since the cracks are prevented from propagating according to the present disclosure as described above, it is possible to prevent the dielectric layer made of ceramics from broken.

The dielectric layer may be made of aluminum oxide.

Aluminum oxide can be produced by anodic oxidizing aluminum. In this regard, the through-holes having the hexagonal regular array are generated by a self-organizing action thereof. It is thus possible to use aluminum oxide as the dielectric layer in the capacitor according to the present disclosure.

According to an embodiment of the present disclosure, there is provided a structure including a dielectric layer having a first plane, a second plane opposite to the first plane, and a plurality of through-holes communicated with the first plane and the second plane, including a plurality of arrangement regions where arrangement directions of the plurality of through-holes are same.

By this configuration, a through-hole arrangement in one arrangement region is different from a through-hole arrangement in the other arrangement region, i.e., the trough-hole is not arranged in a certain direction over an entire area of the dielectric layer. In this way, the cracks are prevented from propagating, even when a mechanical or a thermal shock is added to the dielectric layer. Accordingly, it is possible to prevent capacitor from broken.

According to an embodiment of the present disclosure, there is provided a method of forming a capacitor including preparing a substrate including a plurality of pits orderly arranged, arrangement directions of the plurality of pits being same.

The dielectric layer is formed by anodic oxidizing the substrate.

A conductive material fills a plurality of through-holes formed in the dielectric layer by the anodic oxidation.

By this configuration, when the substrate is anodic oxidized, a formation of the through-holes is promoted based on the pits and it is thus possible to form the dielectric layer where arrangement directions of the plurality of through-holes are same.

In preparing the substrate, the plurality of pits is formed by pressing a mold.

By this configuration, it is possible to form the substrate having the pits in a plurality of arrangement regions.

Hereinafter, embodiments of the present disclosure will be described with reference to the drawings.

### (Capacitor Configuration)

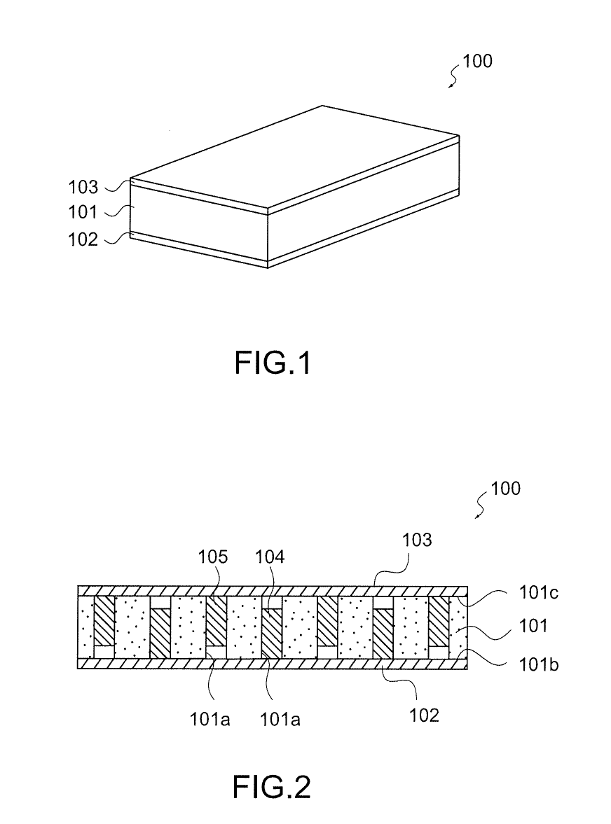

FIG. 1 is a perspective view showing a showing a capacitor 100 according to a first embodiment of the present disclosure. FIG. 2 is a cross-sectional view of the capacitor 100. As shown in these drawings, the capacitor 100 has a dielectric layer 101, a first external electrode layer 102, a second external electrode layer 103, first internal electrodes 104 and second internal electrodes 105.

The first external electrode layer 102, the dielectric layer 101 and the second external electrode layer 103 are laminated in this order. In other words, the dielectric layer 101 is sandwiched between the first external electrode layer 102 and the second external electrode layer 103. The first internal electrodes 104 and the second internal electrodes 105 are formed within the dielectric layer 101 as shown in FIG. 2. Also, the capacitor 100 may have wirings connected to each of the first external electrode layer 102 and the second external electrode layer 103, for example.

The dielectric layer 101 functions as a dielectric of the capacitor 100. The dielectric layer 101 is made of a dielectric material capable of forming through-holes (pores), e.g., aluminum oxide (Al₂O₃). Also, the dielectric layer 101 may be made of an oxide of a bulb metal (Al, Ta, Na, Ti, Zr, Hf, Zn, W, Sb). The thickness of the dielectric layer 101 is not particularly limited. For example, the dielectric layer 101 has a thickness of several μms to hundreds μms.

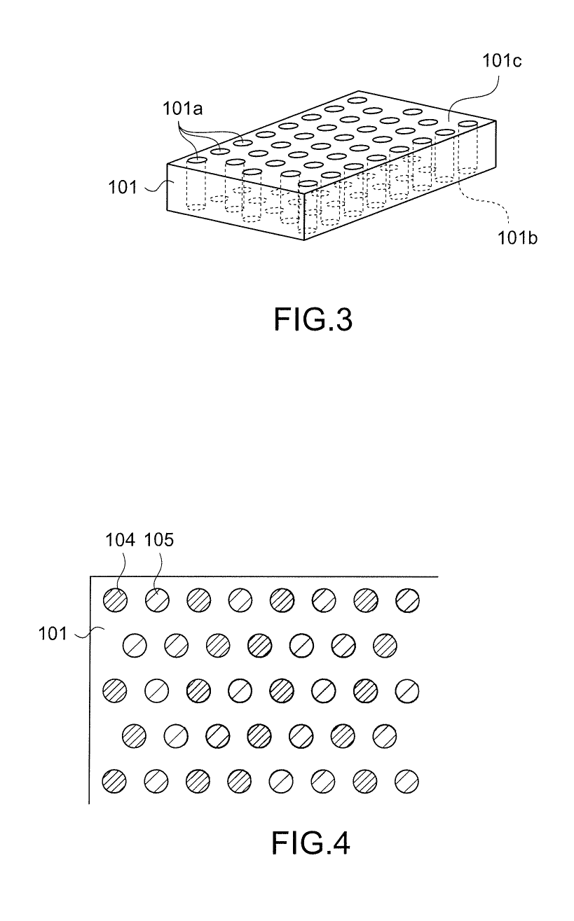

FIG. 3 is a perspective view showing the dielectric layer 101. As shown in FIG. 3, a plurality of through-holes (pores) 101a is formed in the dielectric layer 101. A plane in parallel with a laminar direction of the dielectric layer 101 is defined as a first plane 101b, and an opposite plane thereof is defined as a second plane 101c. Respective through-holes 101a are formed in a direction perpendicular to the first plane 101b and the second plane 101c (in a thickness direction of the dielectric layer 101), and are communicated with the first plane 101b and the second plane 101c. The number and the size of the through-holes 101a shown in FIG. 3 are illustrative. In practice, many smaller-sized through-holes 101a may be formed.

The shape (cross-sectional shape) of each through-hole 101a is not particularly limited, and may be almost circle having an inner diameter of several tens nm to hundreds nms Also, the space of the through-holes 101a adjacent is not particularly limited, and may be several tens nm to hundreds nms.

The through-holes 101a are formed in the dielectric layer 101 by a predetermined arrangement. The arrangement of the through-holes 101a will be described later.

The first external electrode layer 102 functions as an electrode plate of the capacitor 100. The first external electrode layer 102 is disposed on the first plane 101b of the dielectric layer 101. The first external electrode layer 102 may be made of a conductive material, e.g., a pure metal such as Cu, Ni, Cr, Ag, Pd, Fe, Sn, Pb, Pt, Ir, Rh, Ru, Al and Ti or an alloy thereof. The thickness of the first external electrode layer 102 may be several tens nm to several μms. The first external electrode layer 102 may be disposed such that a plurality of conductive material layers is laminated.

The second external electrode layer 103 functions as the electrode plate of the capacitor 100 similar to the first external electrode layer 102. The second external electrode layer 103 is disposed on the second plane 101c of the dielectric layer 101. The second external electrode layer 103 may be made of the conductive material used in the first external electrode layer 102. The thickness of thereof may be several tens nm to several μms. The constituent material of the second external electrode layer 103 may be the same or different as/from the constituent material of the first external electrode layer 102. Also, the second external electrode layer 103 may be disposed such that a plurality of conductive material layers is laminated.

The first internal electrodes 104 are housed in a part of the plurality of through-holes 101a, and are connected to the first external electrode layer 102. Specifically, the first internal electrodes 104 are formed from the first external electrode layer 102 to most of the through-hole 101a, but are not connected to the second external electrode layer 103, as shown in FIG. 2. Between the first internal electrodes 104 and the second external electrode layer 103, spaces or insulators are arranged. The first internal electrodes 104 may be made of a conductive material, e.g., a pure metal such as Cu, Ni, Co, Cr, Ag, Au, Pd, Fe, Sn, Pb and Pt or an alloy thereof.

The second internal electrodes 105 are housed in another part of the plurality of through-holes 101a (the through-hole 101a where the first internal electrodes 104 are not formed), and are connected to the second external electrode layer 103. Specifically, the second internal electrodes 105 are formed from the second external electrode layer 103 to most of the through-hole 101a, but are not connected to the first external electrode layer 102, as shown in FIG. 2. Between the second internal electrodes 105 and the first external electrode layer 102, spaces or insulators are arranged. The material of the second internal electrodes 105 may be the same or different as/from the material of the first internal electrodes 104. In addition, the first internal electrodes 104 and the second internal electrodes 105 may not be always disposed alternately.

FIG. 4 is a schematic view showing a configuration of the first internal electrodes 104 and the second internal electrodes 105 in the dielectric layer 101, and the dielectric layer 101 is viewed from the first plane 101b or the second plane 101c. As shown in FIG. 4, the first internal electrodes 104 and the second internal electrodes 105 can be arranged into a plurality of through-holes 101a at almost same number and randomly. The arrangement of the first internal electrodes 104 and the second internal electrodes 105 is determined by a process of manufacturing the capacitor 100 as described later. A numerical percentage of the first internal electrodes 104 and the second internal electrodes 105 is not particularly limited. However, it is desirable that the percentage of respective electrodes is similar, as the capacitor 100 can have high capacity.

The capacitor 100 has the above-described configuration. As shown in FIGS. 2 and 4, the first internal electrodes 104 and the second internal electrodes 105 are faced each other via the dielectric layer 101 to configure the capacitor. The first internal electrodes 104 are conducted to the first external electrode layer 102, and are connected externally via the first external electrode layer 102. The second internal electrodes 105 are conducted to the second external electrode layer 103, and are connected externally via the second external electrode layer 103.

The first internal electrodes 104 and the second internal electrodes 105 have nano-scaled microstructures, and are adjacent each other. A number of the first and second internal electrodes 104 and 105 can be arranged per unit area. It is thus possible to provide the capacitor 100 having higher capacity than typical capacitors (Al electric field capacitor, a laminated ceramic capacitor, etc.).

### [Through-Hole Arrangement]

As described above, the through-holes 101a formed in the dielectric layer 101 are holes through which the first internal electrodes 104 and the second internal electrodes 105 are housed. It is desirable that a number of the through-holes 101a be formed throughout the dielectric layer 101 so that the capacitor 100 has high capacity. The dielectric layer 101 according to the present disclosure is formed by arranging the through-holes 101a as follows:

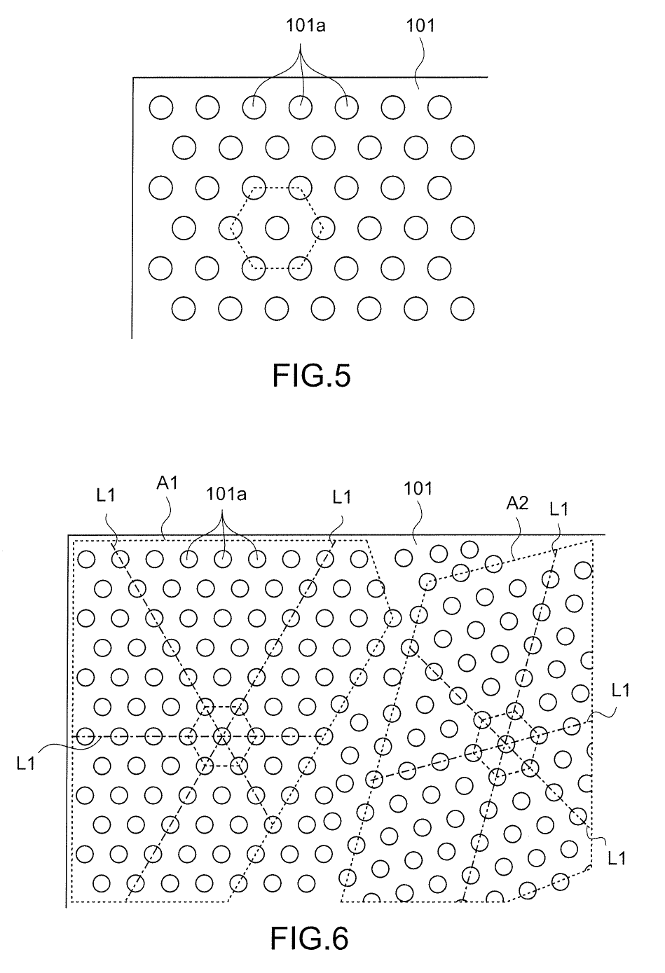

FIG. 5 is a plan view showing a part of the dielectric layer 101 viewed from the first plane 101b or the second plane 101c. As shown in FIG. 5, the through-holes 101a can have a hexagonal ordered array in a laminar direction of the dielectric layer 101. The hexagonal ordered array is an array where a center of each through-hole 101a is disposed at a vertex of a regular hexagon. The hexagonal regular array of the through-holes 101a is generated by a self-organizing action (as described later) of aluminum oxide in the dielectric layer 101. When the dielectric layer 101 is made of a material different from aluminum oxide, the through-holes 101a may have an arrangement different from the hexagonal regular array.

In addition, the through-holes 101a may be arranged in a broader range of the dielectric layer 101 as follows: FIG. 6 is a plan view of a part of the dielectric layer 101 viewed from the first plane 101b or the second plane 101c, and shows a range broader than that shown in FIG. 5. As shown in FIG. 6, the through-holes 101a in a hexagonal ordered array have different arrangement directions per certain range. The arrangement directions herein refer to directions of lines passing through centers of respective through-holes 101a as shown by lines L1 in FIG. 6. In each hexagonal ordered array of the through-holes 101a, the arrangement directions are deviated 120 degrees each other.

In the laminar direction of the dielectric layer 101, an “arrangement region” is defined as a region where the arrangement directions of the through-holes 101a are same. As shown in FIG. 6, the dielectric layer 101 has a plurality of arrangement regions. The arrangement directions in one arrangement region are different or deviated from the arrangement directions in the other arrangement region. In FIG. 6, one arrangement region is shown as a region A1, and the other region is shown as a region A2. Although only the regions A1 and A2 are shown in FIG. 6, a plurality of arrangement regions will be formed in a broader range.

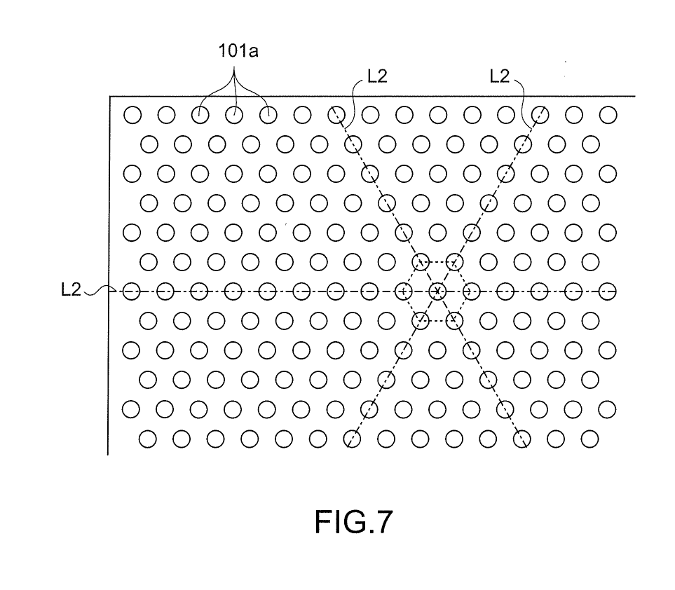

When the plurality of arrangement regions are thus formed in the dielectric layer 101, i.e., when the arrangement directions in the through-holes 101a are not same over the entire area, there may be provided the advantages as described below. FIG. 7 shows a comparison arrangement of the through-holes 101a when the arrangement directions of the through-holes 101a are same over the entire area of the dielectric layer 101, i.e., when only one arrangement region is formed. In FIG. 7, the arrangement directions of the through-holes 101a are shown by lines L2.

In general, cracks and fissures are easily propagated along one direction. As an example, a mechanical strength is decreased along the through-holes 11a arranged in one of the arrangement directions of the through-holes 101a shown by the lines L2. This means that when a mechanical or thermal shock is added to the dielectric layer 101 along one of the arrangement directions, the cracks are propagated along one of the directions, and the dielectric layer 101 may be broken. The dielectric layer 101 functions as a dielectric of the capacitor between the first internal electrodes 104 and the second internal electrodes 105. Therefore, once the dielectric layer 101 is broken, the functions of the capacitor may be significantly lowered or lost.

In contrast, the dielectric layer 101 according to the embodiment as shown in FIG. 6, the plurality of arrangement regions (A1 and A2 and so on) are formed, and the arrangement directions (lines L1) are different or deviated per the arrangement region as described above. In this way, the cracks are prevented from propagating at boundaries of the arrangement regions, even when the shock is added to the dielectric layer 101 along a direction parallel to one arrangement direction. In other words, the dielectric layer 101 is prevented from broken (see Examples).

In addition, an effective size of each arrangement region is that a longest straight line drawn in one arrangement region is from 0.1 μm to 8 μm.

As described above, as the plurality of arrangement regions where the arrangement directions of the through-holes 101a are same in the dielectric layer 101 according to the embodiment, it is possible to increase the mechanical and thermal strength as compared with that including one arrangement region. The method of forming the dielectric layer 101 having such a plurality of arrangement regions will be described next.

### [Method of Forming Capacitor]

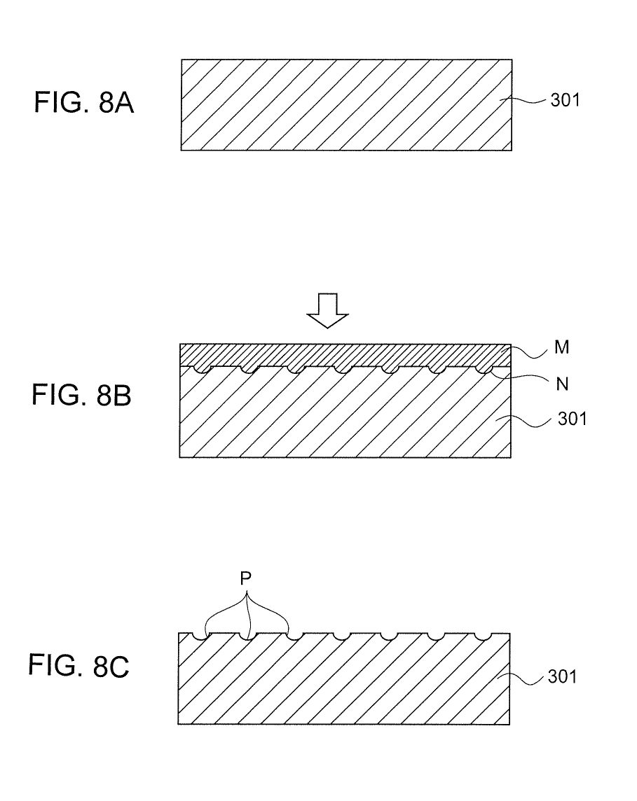

A method of forming the capacitor 100 will be described. FIGS. 8 to 12 are schematic diagrams showing a method of forming the capacitor 100.

FIG. 8A shows a substrate 301 that will be the dielectric layer 101. When the dielectric layer 101 is made of a metal oxide (for example, aluminum oxide), the substrate 301 is made of a metal before oxidation (for example, aluminum).

As shown in FIG. 8B, a mold M is pressed to the surface of the substrate 301. As shown in FIG. 8C, pits are formed on the surface of the substrate 301. At a later step, the metal oxide (the dielectric layer 101) is grown based on the pits P. Accordingly, by forming the mold M at a predetermined shape, it is possible to form the dielectric layer 101 having a plurality of arrangement regions as described above.

As shown in FIG. 8B, the mold M can have a shape where a plurality of convex portions N is formed at a face that is pressed to the substrate 301 (hereinafter referred to as “press face”). There is a plurality of arrangement regions; one arrangement region includes the convex portions N having the same direction.

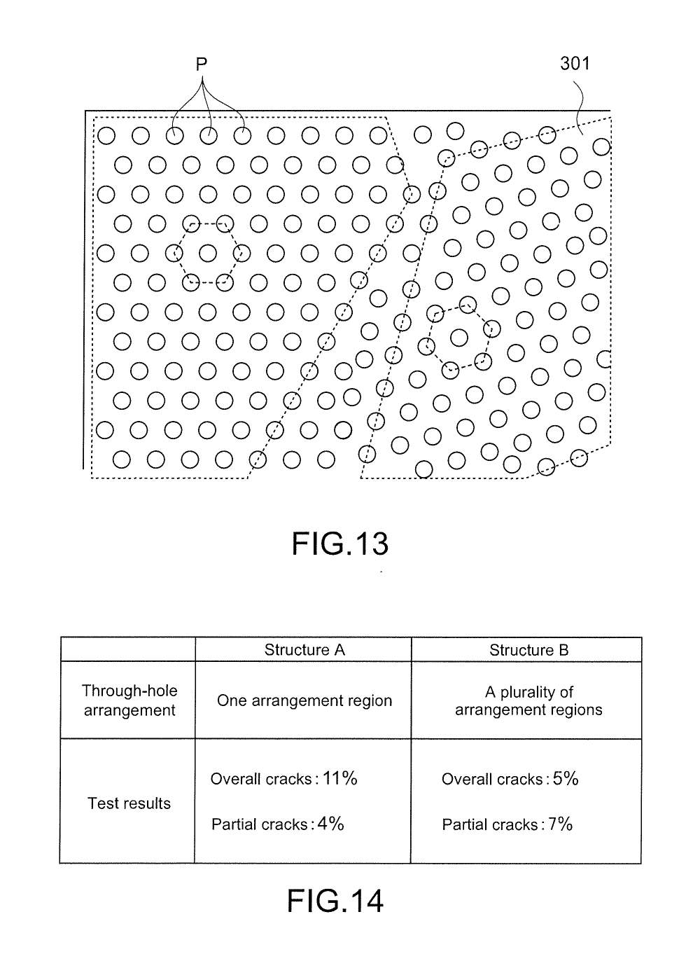

When the mold M is pressed to the substrate 301, the convex portions N of the mold M are transferred to the substrate 301, and pits P are formed corresponding to the convex portions N. FIG. 13 is a schematic diagram showing an arrangement of the pits P formed in the substrate 301. As shown in FIG. 13, the substrate 301 has a plurality of arrangement regions (shown in dashed lines); one arrangement region includes the pits P having the same direction.

The mold M may have any shape as long as the pits P arranged can be formed. A concave convex structure corresponding to the pits P may be possible instead of the convex portions N. Also, the pits P can be formed not only by pressing with the mold M, but also by etching, for example.

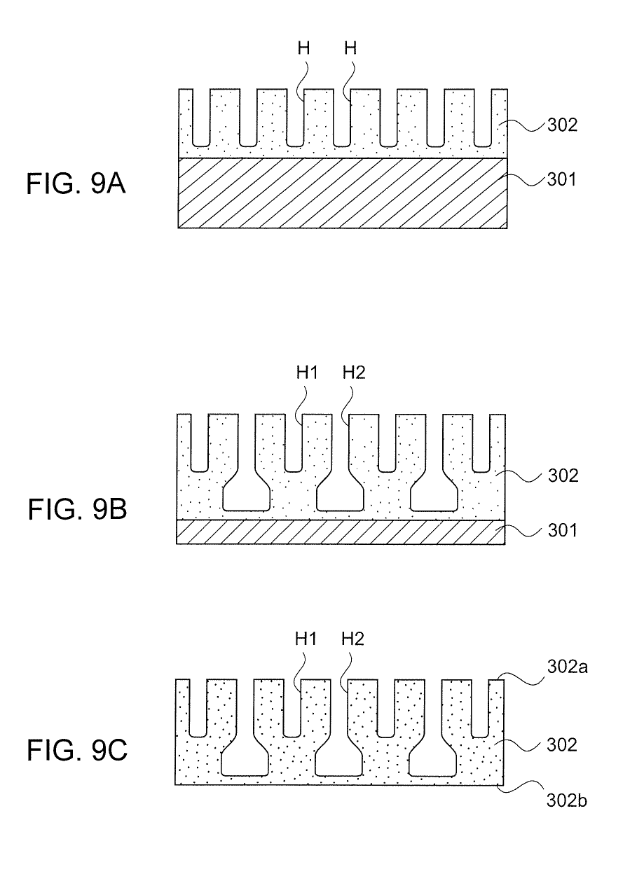

Next, a voltage is applied using the substrate 301 on which the pits P are formed as an anode. In this way, the metal surface of the substrate 301 is oxidized (anodic oxidized) and a substrate oxide 302 is formed, as shown in FIG. 9A. In this case, by the self-organizing action of the substrate oxide 302, holes H are formed in the substrate oxide 302. The holes H are formed in a direction of oxidation processes, i.e., in a thickness direction of the substrate 301. During the formation, as the pits P are initially formed in the substrate 301, the holes H are formed based on respective pits P in the substrate oxide 302.

After the predetermined time elapses, the voltage applied to the substrate 301 is increased. Pitches between the holes H formed by the self-organizing action are determined depending on the magnitude of the applied voltage. The self-organizing action proceeds so that the pitches of the holes H are enlarged. In this way, some holes H continue to be formed and enlarged, as shown in FIG. 9B. On the other hand, the formation of some holes H stops due to the enlarged pitches of the holes H. Hereinafter, the holes H where the formation stops are referred to as holes H1, and the holes H where the formation continues (the holes are enlarged) are referred to as holes H2.

The conditions of the anodic oxidation can be set arbitrarily. For example, the applied voltage can be set to several V to hundreds V and the processing time can be set to several minutes to several days at a first stage of the anodic oxidation shown in FIG. 9A. The voltage value can be set to several times greater than that in the first stage and the processing time can be set to several minutes to several days at a second stage of the anodic oxidation shown in FIG. 9B.

For example, when the applied voltage at the first stage is set to 40V, the holes H (the holes H1 and H2) each having a hole diameter of 100 nm are formed, and when the applied voltage at the second stage is set to 80V, the holes H2 each has an enlarged hole diameter of 200 nm. By limiting the voltage at the second stage to the above-described range, the numbers of the hole H1 and the hole H2 can be almost the same. By limiting the time for applying the voltage at the second stage within the above-described range, the substrate oxide 302 formed by applying the voltage at the second stage can be thin, while a pitch conversion of the holes H2 is fully completed. Since the substrate oxide 302 formed by applying the voltage at the second stage is removed at a later step, it is desirable that the substrate oxide 302 is as thin as possible. The solution used for the anodic oxidation can be oxalic acid (0.1 mol/l) controlled at a temperature of 15 to 20° C., for example.

Then, as shown in FIG. 9C, the substrate 301 not oxidized is removed. The removal of the substrate 301 can be done by wet etching, for example. Hereinafter, a surface where the holes H of the substrate oxide 302 are formed is defined as a front surface 302a, and the opposite side thereof is defined as a back surface 302b.

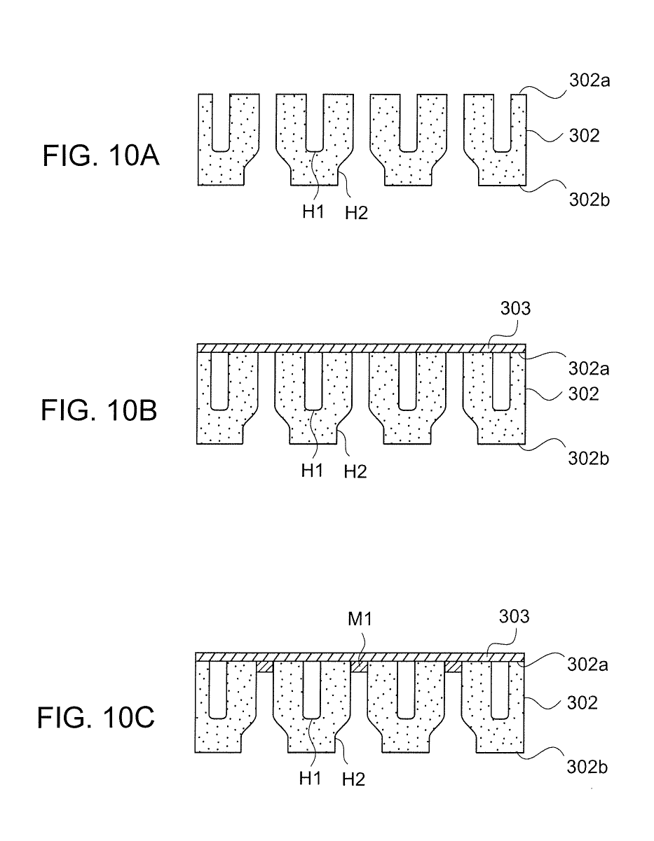

Then, as shown in FIG. 10A, the substrate oxide 302 is removed from the back surface 302b at a predetermined thickness. The removal can be made by a reactive ion etching (RIE). In this case, the substrate oxide 302 is removed to provide a thickness such that the holes H2 are communicated with the back surface 302b, but the holes H1 are not communicated with the back surface 302b.

Then, as shown in FIG. 10B, a first conductive layer 303 containing a conductive material is formed on the front surface 302a of the substrate oxide 302. The first conductive layer 303 can be formed by any method including a sputtering method, a vacuum vapor deposition method or the like.

Then, the substrate oxide 302 is electrolytic plated using the first conductive layer 303 as a seed layer. As shown in FIG. 10C, a plated conductor M1 is formed in the holes H2 at a predetermined thickness. Since no plating liquid enters into the holes H1, no plated conductor M1 is formed in the holes H1.

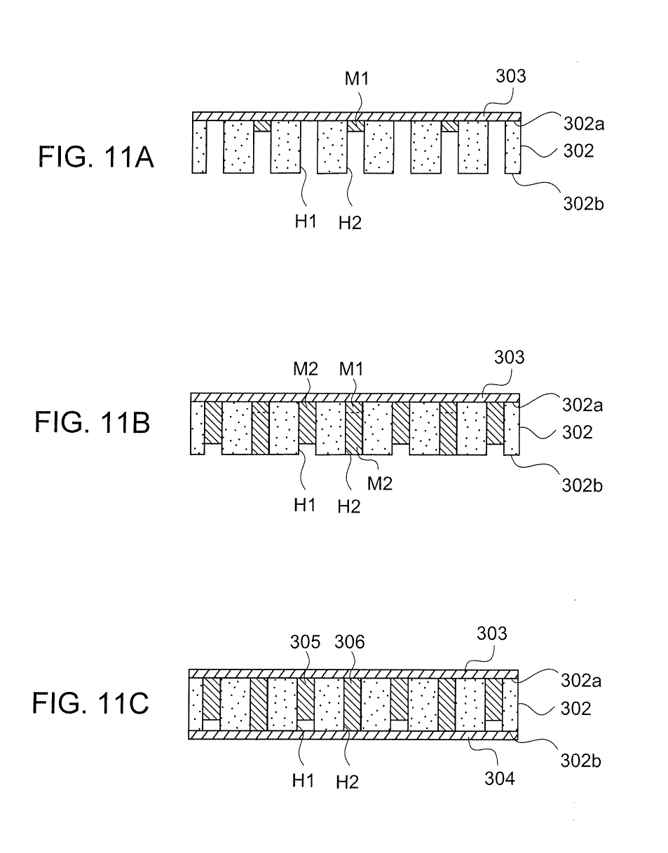

Then, as shown in FIG. 11A, the substrate oxide 302 is again removed from the back surface 302b at a predetermined thickness. The removal can be made by the RIE. In this case, the substrate oxide 302 is removed to provide a thickness such that the holes H1 are communicated with the back surface 302b.

Then, the substrate oxide 302 is again electrolytic plated using the first conductive layer 303 as the seed layer. As shown in FIG. 11B, a plated conductor M2 is formed in the holes H1 and H2 at a predetermined thickness. The thickness of the plated conductor M2 is such that the holes H2 can be filled. In the holes H1, no plated conductor M1 is formed. Therefore, the plated conductor M2 will not reach the lengths of the holes H1. The plated conductor M2 may be made of a metal material that is similar or different metal material of the plated conductor M1.

In the holes H1, voids having no plated conductor M2 filled may be left untouched, or may be filled with an insulating material. In the following description, the voids are left untouched. If the insulating material is filled, the insulating material can be the metal oxide similar to that used in the substrate oxide 302, an electrodepositable resin material (for example, polyimide, epoxy, acrylic etc.), SiO or the like. A thickness of the voids can be set depending on a device capacitance of the capacitor 100, withstand voltage or the like, and can be from several tens nm to several tens μms.

In the following description, the plated conductors M2 filled in the holes H1 are shown first electrode columns 305, and the plated conductors M1 and M2 filed in the holes H2 are shown as second electrode columns 306.

Then, as shown in FIG. 11C, a second conductive layer 304 containing a conductive material is formed on the back surface 302b of the substrate oxide 302. The second conductive layer 304 can be formed by any method including a sputtering method, a vacuum vapor deposition method or the like.

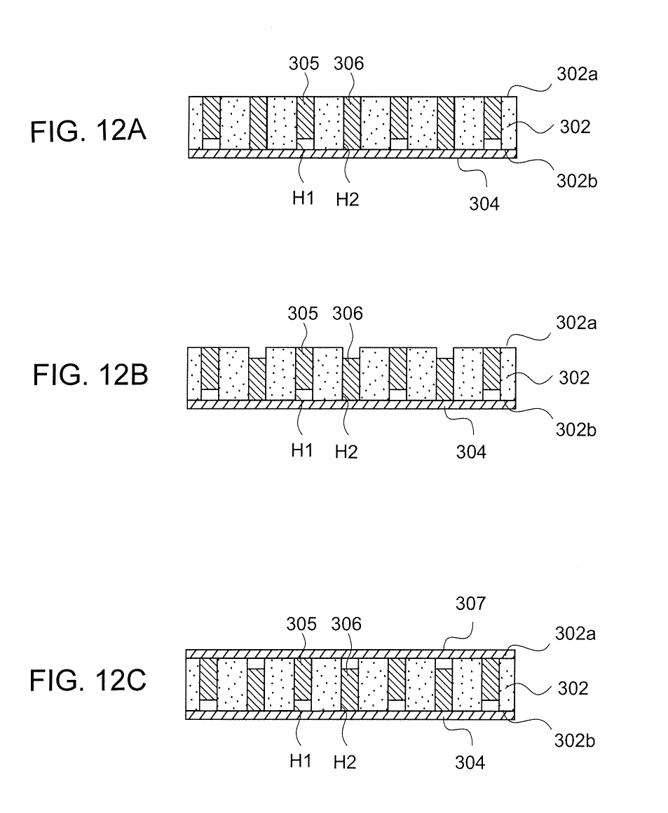

Then, as shown in FIG. 12A, the conductive layer 303 is removed. The removal of the conductive layer 303 can be done by wet etching method, a dry etching method, an ion milling method, a Chemical Mechanical Polishing (CMP) method, or the like.

Then, the substrate oxide 302 is electrolytic etched using the second conductive layer 304 as a seed layer. As shown in FIG. 12B, second electrode columns 306 are conducted to the second conductive layer 304 and are thus etched by electrolytic etching. On the other hand, first electrode columns 305 are not conducted to the second conductive layer 304 and are not etched by electrolytic etching.

In the holes H2, voids formed by etching the second electrode columns 306 may be left untouched, or may be filled with an insulating material. In the following description, the voids are left untouched. If the insulating material is filled, the insulating material can be the metal oxide similar to that used in the substrate oxide 302, an electrodepositable resin material (for example, polyimide, epoxy, acrylic etc.), SiO or the like. A thickness of each void can be set depending on a device capacitance of the capacitor 100, withstand voltage or the like, and can be from several tens nm to several tens μms.

Then, as shown in FIG. 12C, a third conductive layer 307 containing a conductive material is formed on the front surface 302a of the substrate oxide 302. The third conductive layer 307 can be formed by any method including a sputtering method, a vacuum vapor deposition method or the like.

In this way, the capacitor 100 is formed. The substrate oxide 302 corresponds to the dielectric layer 101, the second conductive layer 304 corresponds to the first external electrode layer 102, and the third conductive layer 307 corresponds to the second external electrode layer 103, respectively. Similarly, the second electrode columns 306 correspond to the first internal electrodes 104, and the first electrode columns 305 correspond to the second internal electrodes 105, respectively.

In the method according to the present disclosure, the substrate 301 having the pits P in a plurality of arrangement regions is oxidized to form the substrate oxide 302. In this way, the self-organization of the substrate oxide 302 is promoted based on respective pits P and it is thus possible to form the dielectric layer 101 having the trough-holes 101a in a plurality of arrangement regions.

### [Structure]

The dielectric layer 101 (see FIG. 3) can be used alone as the structure. The structure has the plurality of through-holes 101a. There is a plurality of arrangement regions where the arrangement directions of the through-holes 101a are same. As described above, the structure can have higher mechanical and thermal strength as compared with that including one arrangement region.

While the embodiments of the present disclosure are described, it should be appreciated that the invention is not limited to the above-described embodiments, and variations and modifications may be made without departing from the spirit and scope of the present disclosure.

### EXAMPLE

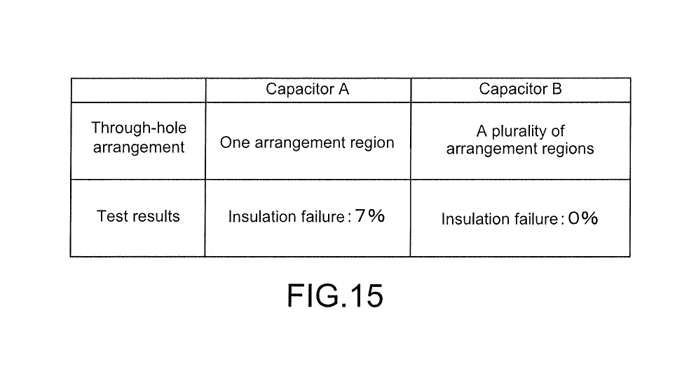

The strengths of the capacitor and the structure as described in the embodiments were confirmed by tests. FIGS. 14 and 15 are tables showing the test results.

### (Working Examples of Structure)

As shown in FIG. 14, a structure A (Comparative) and a structure B (Example) were formed. The structure A includes one arrangement region where arrangement directions of the plurality of through-holes are same over the entire area. The structure B includes a plurality of arrangement regions each having a size of 0.5 to 3 μm where arrangement directions of the plurality of through-holes are same over the entire area. The size of the arrangement region is defined by a longest straight line drawable in the arrangement region.

Each size of the structures A and B is 0.3 mm (thickness)×0.3 mm (short side)×0.6 mm (long side). 100 of respective structures A and B were heated on a hot plate at 350° C. for a sufficient time, and were placed and cooled on a metal plate at room temperature. The thermal load was repeated 10 times. Thereafter, the structures A and B were observed for cracks.

Overall cracks were generated on eleven structures A (11%) and partial cracks were generated on four structures A (4%). Overall cracks were generated on five structures B (5%) and partial cracks were generated on seven structures A (7%). The partial cracks on the structures B were stopped at boundaries in the arrangement regions. The results reveal that the cracks are prevented from propagating at the boundaries in the arrangement regions of the structures B, and the overall cracks in the structures B can be more prevented from generating than the structures A.

### (Working Examples of Capacitor)

As shown in FIG. 15, a capacitor A (Comparative) and a capacitor B (Example) were formed. The capacitor A includes one arrangement region where arrangement directions of the plurality of through-holes are same over the entire area. The capacitor B includes a plurality of arrangement regions each having a size of 0.5 to 3 μm where arrangement directions of the plurality of through-holes are same over the entire area. The size of the arrangement region is defined by a longest straight line drawable in the arrangement region.

Each size of the capacitors A and B is 0.3 mm (thickness)×0.3 mm (short side)×0.6 mm (long side). 100 of respective capacitors A and B were heated on a hot plate at 350° C. for a sufficient time, and were placed and cooled on a metal plate at room temperature. The thermal load was repeated 10 times. Thereafter, the capacitors A and B were measured for insulation properties and observed for cracks.

Seven (7%) capacitors A had an insulation failure, but no (0%) capacitors B had an insulation failure. As to the capacitors A having the insulation failures, all had overall cracks across the dielectric layers along the arrangement directions of the through-holes. In contrast, as to the capacitors B, no overall cracks were observed across the dielectric layers unlike the capacitors A having the insulation failure. The results reveal that the insulation failure can be prevented because the capacitors B had the through-hole arrangement, i.e., had a plurality of arrangement regions unlike the capacitors A so that the cracks of the dielectric layer is less propagated.

Through the tests of the structures and the capacitors, when each structure (an insulating layer, i.e., the dielectric layer in the capacitor) has a plurality of arrangement regions, the overall cracks are prevented across the structure (the insulating layer), and the insulation failure are induced by the overall cracks can also be prevented.

What is claimed is:

1. A capacitor, comprising:
a dielectric layer having a first plane, a second plane opposite to the first plane, and a plurality of through-holes communicated with the first plane and the second plane, including a plurality of arrangement regions where arrangement directions of the plurality of through-holes are same;
a first external electrode layer disposed on the first plane;
a second external electrode layer disposed on the second plane;
a first internal electrode housed in a part of the plurality of through-holes and connected to the first external electrode layer; and
a second internal electrode housed in a part of the plurality of through-holes and connected to the second external electrode layer.

2. The capacitor according to claim 1, wherein
the through-holes in the arrangement regions have a hexagonal ordered array.

3. The capacitor according to claim 2, wherein
the dielectric layer is made of ceramics.

4. The capacitor according to claim 3, wherein
the dielectric layer is made of aluminum oxide.

5. A structure, comprising:
a dielectric layer having a first plane, a second plane opposite to the first plane, and a plurality of through-holes communicated with the first plane and the second plane, including a plurality of arrangement regions where arrangement directions of the plurality of through-holes are same.

6. A method of forming a capacitor, comprising:
preparing a substrate including a plurality of pits orderly arranged, arrangement directions of the plurality of pits being same;
forming a dielectric layer by anodic oxidizing the substrate;
filling a plurality of through-holes formed in the dielectric layer by the anodic oxidation with a conductive material.

7. The method according to claim 6, wherein
in preparing the substrate, the plurality of pits are formed by pressing a mold.
